(19) United States
(12) Patent Application Publication
(10) Pub. No.: US 2006/0164612 A1
(43) Pub. Date: Jul. 27, 2006

(54) Electronic device having adjusting assembly

(75) Inventors: Shu-Yi Chen, Taipei City (TW); Chang-Hung Lee, Dounan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/337,430

(22) Filed: Jan. 23, 2006

(30) Foreign Application Priority Data
Jan. 25, 2005 (TW) 94102195

(51) Int. Cl. G03B 21/22

(52) U.S. Cl. 353/119

(57) ABSTRACT

An electronic device including a housing, a first supporting member, a second supporting member and an adjusting assembly is provided. The first and the second supporting members are disposed beneath the housing for supporting the electronic device. The adjusting assembly is coupled to the first and the second supporting members for driving the first and the second supporting members to move towards a first and a second directions respectively.

This application claims the benefit of Taiwan Application Serial No. 094102195, filed Jan. 25, 2005, the subject matter of which is incorporated herein by reference.

### BACKGROUND OF THE INVENTION

1. Field of the Invention

The invention relates in general to an electronic device having an adjusting assembly, and more particularly to a projector capable of adjusting horizontal height synchronously.

2. Description of the Related Art

FIG. 1A is a 3-D diagram of a conventional projector. Referring to FIG. 1A, conventional projector 10 includes a housing 11, a projection lens 12 and four supporting legs 13, 14, 15 and 16. The projection lens 12 is disposed on the side wall of the housing 11 for projecting an image onto a monitor. The supporting legs 13, 14, 15 and 16 are disposed on lithe bottom surface of the housing for supporting the housing 11. The supporting legs 15 and 16 are positioned at the rear end of the housing 11 and fixed on the housing 11. The supporting legs 13 and 14 can be adjusted the length exposed outside the housing 11 for changing the projection angle of the projector or the level of the projection image to generate optimal height, size and position for the viewer.

FIG. 1B is a front view of a conventional projector. Referring to FIG. 1B, a supporting leg 13 includes an adjusting member 13a and a screw 13b. The supporting leg 14 includes an adjusting member 14a and a screw 14b. In the supporting leg 13, the adjusting member 13a has a thread, and the adjusting member 13a is screwed to the screw 13b by coupling to the thread. When the screw 13b rotates anti-clockwise, the screw 13b is raised up, causing the supporting leg 13 exposed outside the housing 11 to be reduced. Meanwhile, the supporting leg 14 needs to be adjusted accordingly for the angle of elevation of the projector to be lowered.

However, the user has to repeatedly adjust the supporting legs 13 and 14 for the two legs to shift relatively so as to adjust the projector. Particularly, when the projector 10 is placed on an uneven desk, the user has to spend more time to place the projector on the desk stably.

FIG. 2A is a disposition diagram of a supporting leg 23 of a conventional projector 20. The disposition of the supporting leg 23 differs with the projector of FIG. 1A in that a supporting leg 23 is used to replace the above supporting legs 13 and 14. Referring to FIG. 2A, a projection lens 22 is disposed at the front end of the housing 21. The supporting leg 23 positioned at the front end of the housing 21 can adjust the length of the part exposed outside the housing 21, and the supporting legs 24 and 25 positioned at the rear end of the housing 21 are not adjusted.

FIG. 2B is a disposition diagram of another supporting leg of a conventional projector. The disposition of the supporting leg differs with the above disclosure in that the four supporting legs 33, 34, 35 and 36 are adjustably disposed on the housing. In conventional projector 30, the projection lens 32 is disposed in the front end of the housing 31, while the four supporting legs 33, 34, 35 and 36 are respectively disposed on the four corners of the housing.

However, the user has to repeatedly adjust the supporting legs 33, 34, 35 and 36 back and forth for the four legs to make the same shift so as to adjust the position of the projector. Particularly, when the projector 30 is placed on an uneven desk, the user needs to use fine and careful adjustment for the projector to be stably placed on the desk so that the image is correctly projected on the monitor without tilting to any side.

That is, the supporting members of conventional projector perform absolute micro-adjustment with respect to every supporting member. With more supporting members being used, the projector can be flexibly adjusted according to various environments. However, more efforts are required for the height and balance of the desk to be adjusted so as to achieve desired angle of projection. On the contrary, the adjusting process can be simplified if the number of adjustable supporting members is reduced. However, it can not adjust various standing plane. The adjusting mechanism of conventional projector is either too complicated or too simplified.

### SUMMARY OF THE INVENTION

It is therefore the object of the invention to provide an electronic device having an adjusting assembly. The adjusting assembly connects two supporting members adjusted according to their relative height, so that adjusting process is simplified. Moreover, the adjusting assembly of the present embodiment can move the two supporting members in opposite directions to adjust the relative height of the supporting members, so that the electronic device and the horizontal line can form various contained angles according to the standing planes. Particularly, the electronic device has several adjustable supporting members, so the adjusting assembly of the invention can adjust according to the standing planes under various environments to simplify the adjusting process.

According to an object of the invention, an electronic device including a housing, a first supporting member, a second supporting member and an adjusting assembly is provided. The first and the second supporting members are disposed beneath the housing for supporting the electronic device. The adjusting assembly is coupled to the first and the second supporting members for driving the first and the second supporting members to move towards a first and second directions respectively.

According to yet another object of the invention, an adjusting assembly disposed in an electronic device is provided. The electronic device at least includes a housing, a first supporting member and a second supporting member. The first and the second supporting members are disposed on the bottom surface of the housing and respectively positioned at the two sides of the electronic device. The adjusting assembly includes an adjusting member and a intermediate member. The adjusting member is positioned between the first supporting member and the second supporting member. The intermediate member connects the first supporting member, the second supporting member and the adjusting member. The intermediate member is coupled to a first track of the first supporting member and a second track of the first supporting member. When the adjusting member drives the intermediate member, the intermediate member respectively move along the first track and the second track, so that the intermediate member drives the first and the second supporting members to move towards the first and the second directions.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a 3-D diagram of a conventional projector;

FIG. 1B is a front view of a conventional projector;

FIG. 2A is a disposition diagram of a supporting member of a conventional projector;

FIG. 2B is a disposition diagram of another supporting member of a conventional projector;

FIG. 3A is a front view of an electronic device according to the first embodiment of the invention,

FIG. 3B is a front perspective of an electronic device of FIG. 3A;

FIG. 4 is a perspective of an electronic device with an adjusting assembly according to the second embodiment of the invention;

FIG. 5A is a front view of an electronic device according to the first embodiment of the invention; and

FIG. 5B is a front perspective of an electronic device of FIG. 5A.

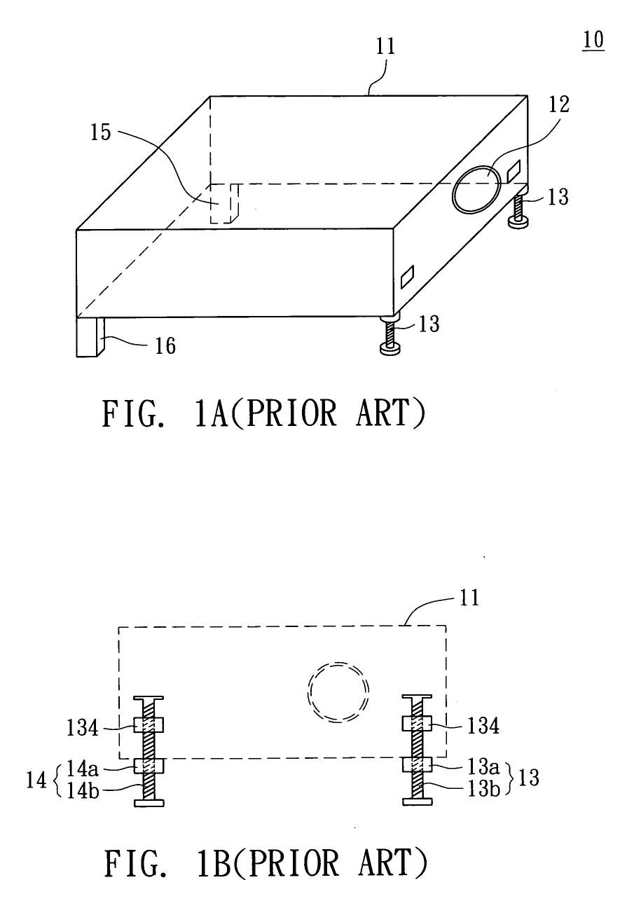

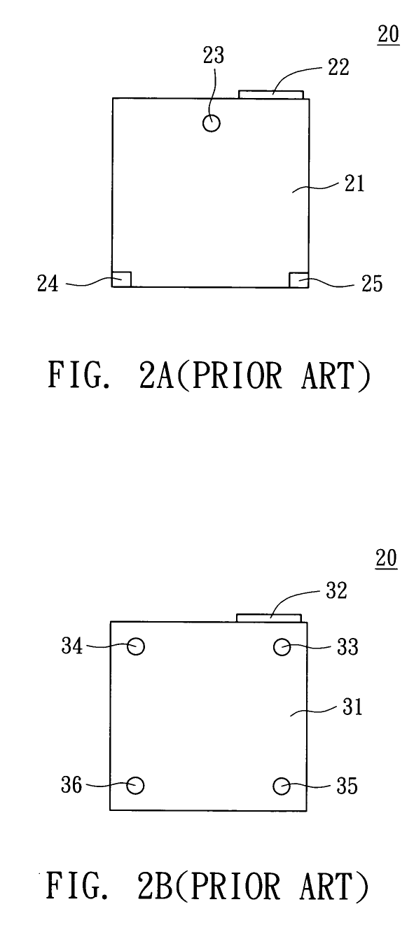

### DETAILED DESCRIPTION OF THE INVENTION

The main concept of the invention is to provide an electronic device whose adjusting assembly connects two supporting members which are adjusted according to their relative height so that the adjusting process is simplified. Particularly when the electronic device has several adjustable supporting members, the adjusting assembly of the invention is capable of performing adjustment according to the various standing plane and simplifying the adjusting process at the same time.

The electronic device of the invention includes a housing, a first supporting member, a second supporting member and an adjusting assembly. The first supporting member is disposed in the housing and projects from the bottom of the housing. The second supporting member is disposed in the housing and projects from the bottom of the housing. The first and second supporting members are used for supporting the electronic device. The adjusting assembly is coupled to the first and second supporting members for driving the first and second supporting members to move towards the first and second directions respectively.

The adjusting assembly includes an adjusting member and an intermediate member. The adjusting member is positioned between the first supporting member and the second supporting member. The intermediate member connects the first supporting member, the second supporting member and the adjusting member. When the adjusting member drives the intermediate member to move along the first and second tracks, so that the intermediate member drives the first and second supporting members to move towards the first and second directions respectively.

The following embodiments are exemplified by a projector. However, the embodiments are only within the spirit of the invention, and the scope of protection of the invention is not limited thereto.

### FIRST EMBODIMENT

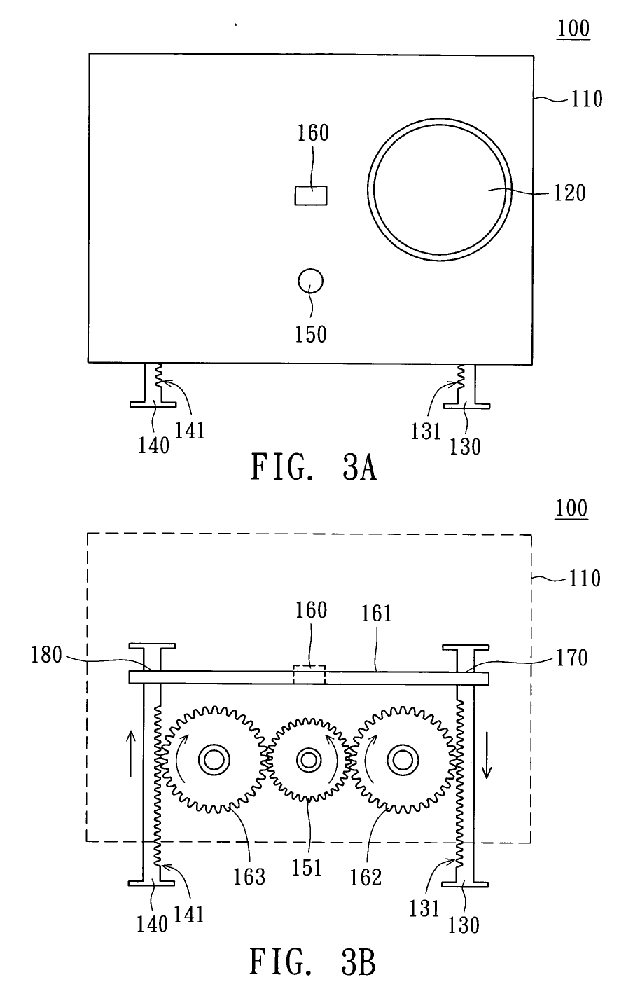

FIG. 3A is a front view of an electronic device according to the first embodiment of the invention. Electronic device 100 of the present embodiment includes a housing 110, a first supporting member 130, a second supporting member 140 and an adjusting assembly. The first supporting member 130 and the second supporting member 140 are disposed in the housing 110 and project from the bottom surface of the housing 110. The first supporting member 130 and the second supporting member 140 are used for supporting the electronic device 100. The first supporting member 130 and the second supporting member 140 respectively have a first track and a second track. For example, the first track and the second track respectively can be a first rack 131 and a second rack 141.

FIG. 3B is a front perspective of an electronic device of FIG. 3A. The adjusting assembly includes an adjusting member and an intermediate member. The adjusting member, such as a first gear 151 for instance, is positioned between the first supporting member 130 and the second supporting member 140. The intermediate member, such as a second gear 162 and a third gear 163 for instance, connects the first supporting member 130, the second supporting member 140 and the adjusting member. The second gear 162 is respectively engaged with the first rack 131 and the first gear 151. The third gear 163 is respectively engaged with the second rack 141 and the first gear 151. When the first gear 151 drives the second gear 162 and the third gear 163 to rotate, the second gear 162 pushes the first supporting member 130 to move along the first direction, and the third gear 163 pushes the second supporting member 140 to move along the second direction. Preferably, the first direction and the second direction physically form a contained angle of 180°. For example, the first direction faces the top surface of the electronic device, the second direction faces the bottom surface of the electronic device, and the horizontality of the electronic device is adjusted by the intermediate member.

As shown in FIG. 3A, the adjusting member further includes a knob 150 mounted on the first gear 151 and positioned outside the housing 110. The knob 150 and the first gear 151 are disposed on the same axis for driving the first gear 151 to rotate. That is, the user does not need to back and forth adjust respective supporting members. The user can change the relative height between the two sides of the projector by adjusting the knob only. Moreover, the adjusting assembly of the present embodiment moves the two supporting members in opposite directions, so that the two supporting members are separated by two units when the adjusting assembly is adjusted by one unit, and that the adjusting process is speeded up.

Besides, the adjusting assembly further includes a rod 161 and a controlling member 160. One end the rod 161 is held at a retaining portion 170 of the first supporting member 130, and another end is held at a retaining portion 180 of the second supporting member 140. The controlling member 160 is connected to the rod 161 and disposed on the surface of the housing 110 for controlling the rod to drive the retaining portion 170 and the retaining portion 180, and meanwhile holds or releases the first supporting member 130 and the second supporting member 140. When the retaining portion 170 and the retaining portion 180 hold the first supporting member 130 and the second supporting member 140, the first supporting member 130 and the second supporting member 140 are fixed at a specific height. When the retaining portion 170 and the retaining portion 180 release the first supporting member 130 and the second supporting member 140, the first supporting member 130 and the second supporting member 140 come down to be exposed outside the housing 110.

For example, the electronic device 100 is a projector including a projection lens 120 positioned on a first lateral side of the housing 110. The first supporting member 130 and the second supporting member 140 are respectively positioned on the two sides of the projection lens 120. The adjusting assembly changes the horizontal angle of the first lateral side by adjusting the length of the part of the first supporting member 130 and the second supporting member 140 exposed outside the housing 110. Thus, by adjusting the controlling member 160 to a certain length, the first supporting member 130 and the second supporting member 140 are released by the same length, so as to quickly adjust the projecting angle of elevation of the projector.

Furthermore, the present embodiment can adopt two sets of adjusting assemblies. For example, the first supporting member and the second supporting member disposed at the front end of the projector adopt a first set of adjusting assembly, while the third supporting member and the fourth supporting member disposed at the rear end of the projector adopt a second set of adjusting assembly. Thus, when the projector is placed on an uneven desk, the user can adjust the relative height between the two supporting members disposed on the left hand side of the projector and the two supporting members disposed on the right hand side of the projector by adjusting two knobs only. Meanwhile, the projecting image is positioned at a horizontal state and the projector is stably placed on the desk.

### SECOND EMBODIMENT

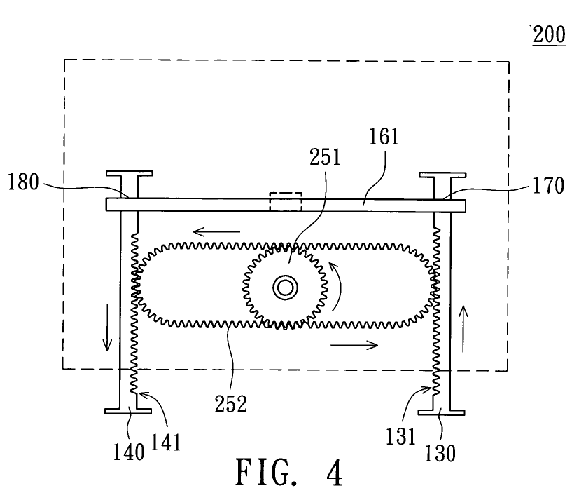

The difference between the present embodiment and the above embodiments is the intermediate member, other components remaining the same and following the same labels are not repeated here. Referring to FIG. 4, a perspective of an electronic device with an adjusting assembly according to the second embodiment of the invention is shown. For example, the intermediate member is performed by a rim 252 in the electronic device 200 of the present embodiment. The rim 252 has a plurality of inner teeth and a plurality of outer teeth, the rim 252 surround the first gear 251, and the inner teeth are engaged with the first gear 251, the outer teeth are engaged with the first rack 131 and the second rack 141. When the first gear 251 drives the rim 252 to rotate, the rim 252 pushes the first supporting member 130 to move along the first direction, and pushes the second supporting member 140 to move along the second direction simultaneously.

### THIRD EMBODIMENT

The present embodiment differs with the above embodiments in the design of the adjusting assembly, the first track and the second track. Other components remaining the same and following the same labels are not repeated here.

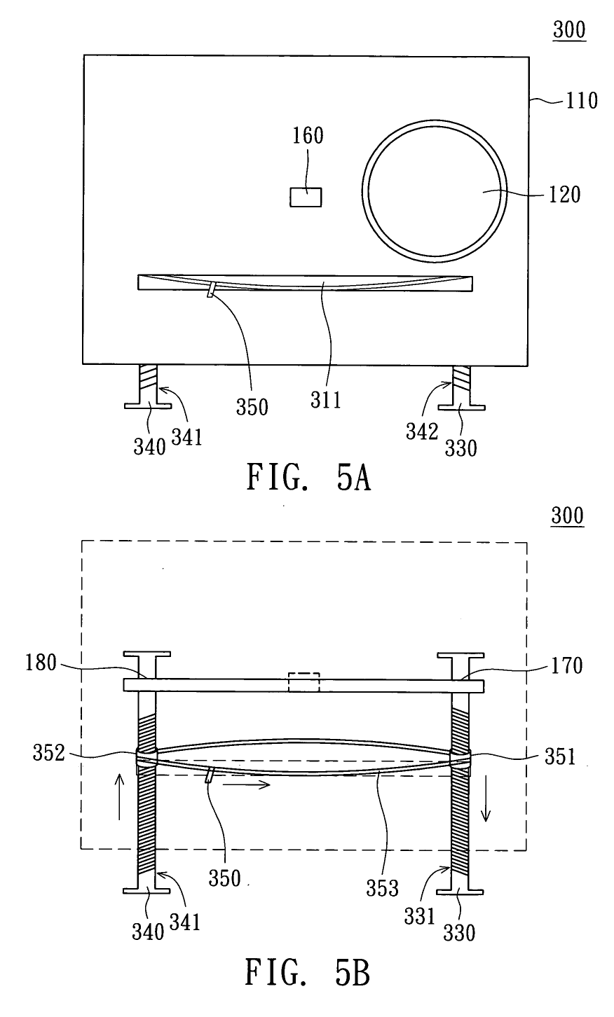

FIG. 5A is a front view of an electronic device according to the first embodiment of the invention. FIG. 5B is a front perspective of an electronic device of FIG. 5A. Referring to FIG. 5A, in the electronic device 300 of the present embodiment, the first track and the second track respectively are a first thread 331 and a second thread 341. The first thread 331 and the second thread 341 are of opposite directions.

The intermediate member includes a first moveable member 351, a second moveable member 352 and a conveyor 353. The first moveable member 351 is mounted and screwed to the first supporting member 130. The second moveable member 352 is mounted and screwed to the second supporting member 140. The conveyor 353, mounted on the peripheral of the first moveable member 351 and the second moveable member 352, presses against the first moveable member 351 and the second moveable member 353. When the conveyor 353 drives the first moveable member 351 and the second moveable member 352 to rotate, the first moveable member 351 pushes the first supporting member 130 to move along the first thread 331 towards the first direction, and the second moveable member 352 pushes the second supporting member 140 to move along the second thread 341 towards the second direction.

Referring to FIG. 5A, the housing 310 of the electronic device 300 has an opening 311. The adjusting member is a bar 350 whose one end is fixed on the conveyor 353 and another end is disposed in the opening 311 and positioned outside the housing 310 for driving the conveyor 353.

According to the electronic device and the adjusting assembly thereof disclosed in above embodiments of the invention, the adjusting assembly connects the two supporting members and can spontaneously and consistently adjust the height of the two supporting members and simplify the adjusting process. The adjusting assembly of the present embodiment moves the two supporting members in opposite directions to adjust the relative height between the supporting members, so that the electronic device and the horizontal line can promptly and flexibly form various contained angles according to the standing planes under various environments to satisfy user's various needs of viewing. The two supporting members are separated by two units when the adjusting assembly is adjusted by one unit, and that the adjusting process is speeded. Furthermore, the present embodiment can adopt two sets of adjusting assemblies. When the projector is placed on an uneven desk, the user can adjust the relative height between the two supporting members disposed on the left hand side of the projector and the two supporting members disposed on the right hand side of the projector by adjusting two knobs only. Meanwhile, the projecting image is positioned at a horizontal state and the projector is stably placed on the desk.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device, comprising:
a housing;
a first supporting member disposed in a bottom surface of the housing;
a second supporting member disposed in the bottom surface of the housing, the first supporting member and the second supporting member supporting the electronic device; and
an adjusting assembly connected to the first supporting member and the second supporting member for driving the first and the second supporting members to move respectively towards a first and a second directions synchronously.

2. The electronic device according to claim 1, wherein the first supporting member and the second supporting member respectively have a first track and a second track, the adjusting assembly comprising:
an adjusting member positioned between the first supporting member and the second supporting member; and
a intermediate member connecting the first supporting member, the second supporting member and the adjusting member;
when the adjusting member drives the intermediate member to move along the first track and the second track, the intermediate member drives the first and the second supporting members to move towards the first and the second directions respectively.

3. The electronic device according to claim 1, wherein the first direction and the second direction physically form a angle of 180°.

4. The electronic device according to claim 1, wherein the first direction faces the top surface of the electronic device, and the second direction faces the bottom surface of the electronic device, so that the horizontality of the electronic device is adjusted by the intermediate member.

5. The electronic device according to claim 2, wherein the first track and the second track are a first rack and a second rack respectively, and the adjusting member comprises a first gear, the intermediate member comprising:
a second gear respectively engaged with the first rack and the first gear; and
a third gear respectively engaged with the second rack and the first gear;
when the first gear drives the second gear and the third gear to rotate, the second gear pushes the first supporting member to move along the first direction, and the third gear pushes the second supporting member to move along the second direction synchronously.

6. The electronic device according to claim 5, wherein the adjusting member further comprises:
a knob mounted on the first gear and positioned outside the housing, wherein the knob and the first gear are disposed on the same axis for driving the first gear to rotate.

7. The electronic device according to claim 2, wherein the first track and the second track respectively are a first rack and a second rack, and the adjusting member comprises a gear, and the intermediate member comprising:
a rim having a plurality of inner teeth and a plurality of outer teeth surrounded the first gear, the inner teeth engaged with the first gear, and the outer teeth engaged with the first and second racks;
when the first gear drives the rim to rotate, the rim pushes the first and second supporting members to move along the first and the second directions respectively.

8. The electronic device according to claim 7, wherein the adjusting member further comprises:
a knob mounted on the first gear and positioned outside the housing, wherein the knob and the first gear are disposed on the same axis for driving the first gear to rotate.

9. The electronic device according to claim 2, wherein the first track and the second track are a first thread and a second thread respectively, the first thread and the second thread are of opposite directions, the intermediate member comprising:
a first moveable member mounted and screwed to the first supporting member;
a second moveable member mounted and screwed to the second supporting member; and
a conveyor mounted on the peripheral of the first moveable member and the second moveable member, wherein the conveyor presses against the first and second moveable members;
when the conveyor drives the first and second moveable members to rotate, the first moveable member pushes the first supporting member along the first thread to move towards the first direction, and the second moveable member pushes the second supporting member along the second thread to move towards the second direction.

10. The electronic device according to claim 9, wherein the housing has an opening, and the adjusting member is a bar whose one end is fixed on the conveyor and another end is disposed in the opening and outside the housing for driving the conveyor.

11. The electronic device according to claim 2, wherein the adjusting assembly further comprises:
a rod whose one end is held at the first supporting member and another end is held at the second supporting member; and
a controlling member connected to the rod and disposed at the surface of the housing for controlling the rod to hold or release the first supporting member and the second supporting member synchronously;
when the rod holds the first and second supporting members, the first and second supporting members are respectively fixed at a specific height; when the rod releases the first and second supporting members, the first and second supporting members come down to be exposed outside the housing.

12. The electronic device according to claim 1, wherein the electronic device is a projector having a projection lens positioned a first lateral side of the housing, the adjusting assembly changing a horizontal angle of the first lateral side by adjusting the length that the first and second supporting members exposed outside the housing.

13. The electronic device according to claim 13, wherein the first and second supporting members are respectively positioned at the two sides of the projection lens.

14. An adjusting assembly disposed in an electronic device, wherein the electronic device comprises a housing, a first supporting member and a second supporting member, the first and second supporting members setting on the bottom surface of the housing and respectively positioned at two sides of the electronic device, the adjusting assembly comprising:
an adjusting member positioned between the first supporting member and the second supporting member; and
a intermediate member connecting the first supporting member, the second supporting member and the adjusting member, wherein the intermediate member is coupled to a first track of the first supporting member and a second track of the first supporting member;
when the adjusting member drives the intermediate member to move along the first and second tracks, the intermediate member drives the first supporting member to move towards the first direction, and the second supporting member moves towards the second direction respectively.

15. The adjusting assembly according to claim 14, wherein the first direction faces the top surface of the electronic device, and the second direction faces the bottom surface of the electronic device, so that the horizontality of the electronic device is adjusted by the intermediate member.

16. The adjusting assembly according to claim 14, wherein the first and second tracks are respectively a first rack and a second rack, and the adjusting member comprises a first gear, the intermediate member comprising:
a second gear respectively engaged with the first rack and the first gear; and
a third gear respectively engaged with the second rack and the first gear;
when the first gear drives the second gear and the third gear to rotate, the second gear pushes the first supporting member to move along the first direction, and the third gear pushes the second supporting member to move along the second direction synchronously.

17. The adjusting assembly according to claim 14, wherein the adjusting member further comprises:
a knob mounted on the first gear and positioned outside the housing, wherein the knob and the first gear are disposed on the same axis for driving the first gear to rotate.

18. The adjusting assembly according to claim 14, wherein the first and second track respectively are a first rack and a second rack, and the adjusting member comprises a gear, the intermediate member comprising:
a rim having a plurality of inner teeth and a plurality of outer teeth, the inner teeth engaged with the first gear, the outer teeth engaged with the first and second racks;
when the first gear drives the rim to rotate, the rim pushes the first and second supporting members to move along the first and the second directions respectively.

19. The adjusting assembly according to claim 14, wherein the first and second tracks respectively are a first thread and a second thread, the first and second threads are of opposite directions, the intermediate member comprising:
a first moveable member mounted and screwed to the first supporting member;
a second moveable member mounted and screwed to the second supporting member;
a conveyor mounted the peripheral of the first moveable member and the second moveable member, wherein the conveyor presses against the first and second moveable members;
when the conveyor drives the first and second moveable members to rotate, the first moveable member pushes the first and second supporting members to move along the first and the second directions respectively.
